(19) United States
(12) Patent Application Publication
(10) Pub. No.: US 2018/0336618 A1
(43) Pub. Date: Nov. 22, 2018

(54) MERCHANDISE PURCHASE ASSIST SYSTEM

(71) Applicants: Yoshimitsu KAGIWADA, Ashigarakamigun Matsudamachi (JP); KEYSOFT, INC., Ashigarakamigun Matsudamachi (JP)

(72) Inventor: Yoshimitsu KAGIWADA, Ashigarakamigun Matsudamachi (JP)

(73) Assignees: Yoshimitsu KAGIWADA, Ashigarakamigun Matsudamachi (JP); KEYSOFT, INC, Ashigarakamigun Matsudamachi (JP)

(21) Appl. No.: 16/041,818

(22) Filed: Jul. 22, 2018

Related U.S. Application Data
(63) Continuation of application No. PCT/JP2017/002193, filed on Jan. 23, 2017.

(30) Foreign Application Priority Data
Jan. 23, 2016 (JP) 2016-011154

(51) Int. Cl. G06Q 30/06

(52) U.S. Cl. CPC G06Q 30/0629

(57) ABSTRACT

A merchandise purchase assist system may include a storage unit storing merchandise-related information concerning merchandise from marketplace sites without providing affiliate services and merchandise-related information concerning merchandise from other marketplace sites, a retrieval conditions acquisition unit receiving a retrieval condition for the merchandise-related information from a purchaser interface system, a retrieval unit retrieving, from the storage unit, the merchandise-related information matching the retrieval condition, and a retrieval results generation unit inserting, into a retrieval results display webpage, one merchandise-publicizing part including the merchandise-related information retrieved by the retrieval unit concerning merchandise at marketplace sites without providing affiliate services, and another merchandise-publicizing part or an affiliate part including the merchandise-related information retrieved by the retrieval unit concerning merchandise at other marketplace sites. The system may transmit the retrieval results display webpage in which the one merchandise-publicizing part and the other merchandise-publicizing part or affiliate part are combined to purchaser interface system.

### CROSS REFERENCE TO RELATED APPLICATIONS

This application is a continuation application of International Application No. PCT/JP2017/126707, filed on Jan. 23, 2017, entitled “MERCHANDISE PURCHASE ASSIST SYSTEM”, the entire contents of which are incorporated herein by reference

### BACKGROUND

The disclosure relates to a merchandise purchase assist system, and more particularly relates to a merchandise purchase assist system that presents merchandise sold at different marketplace sites to consumers in an integrated manner, and thus allows the consumer to compare and select merchandise of the integrated marketplace sites.

The modes of marketplace sites to sell merchandise on the Internet include an online mall including online shops and an EC (Electric Commerce) site that mainly sells its own merchandise on a website operated by itself. The merchandise being sold at the EC site includes attractive merchandise such as local products. However, there is a problem that the merchandise from the EC site does not get increased sales, since the EC site has less chance that the merchandise gets noticed by consumers, than major online malls (for example, “Rakuten Ichiba”, operated by Rakuten, Inc., <URL:http://www.rakulen.co.ip>). On the other hand, when an operator of the EC site opens a store in the major online mall in an attempt to increase sales chance, costs such as a commission fee are increased rather, which may lead to the red.

Moreover, the consumers may compare online malls and EC sites to purchase certain merchandise. However, interfaces for finding target merchandise vary among online malls and EC sites. For this reason, it takes a lot of effort for the consumers to find the target merchandise from a large number of shops and compare the merchandise. For example, the inventor of this application has had a hard time comparing ten reservation sites to make a hotel reservation for a business trip. Particularly, most of smaller hotels are not included in major reservation sites and the like, and it is difficult to even reach reservation sites of such smaller hotels. Moreover, there is even no marketplace site presenting merchandise gathered from major merchandise marketplace sites.

Furthermore, many online malls provide affiliate services. The affiliate services may be provided by the companies of the online malls themselves or may be provided by an affiliate service provider (ASP).

### SUMMARY

A merchandise purchase assist system according to one or more embodiments may include a retrieval conditions acquisition unit that receives a retrieval condition for the merchandise-related information from a purchaser interface system, and a retrieval unit that retrieves, from the storage unit, the merchandise-related information matching the retrieval conditions. The disclosure further includes a retrieval results generation unit that inserts, into a retrieval results display webpage, one merchandise-publicizing part including the merchandise-related information retrieved by the retrieval unit concerning merchandise at marketplace sites that do not provide affiliate services, and another merchandise-publicizing part or an affiliate part including merchandise-related information retrieved by the retrieval unit concerning merchandise at other marketplace sites. The retrieval results display webpage in which the one merchandise-publicizing part and the other merchandise-publicizing part or affiliate part may be combined is provided to the purchaser interface system.

### BRIEF DESCRIPTION OF DRAWINGS

FIG. 1 is an overall configuration diagram illustrating a merchandise purchase assist system according to one or more embodiments;

FIG. 2 is a view illustrating configuration diagram of a cross-search function according to one or more embodiments;

FIG. 3 is a view illustrating a data structure of merchandise-related information on merchandise that is a target for affiliate services according to one or more embodiments;

FIG. 4 is a view illustrating a data structure of merchandise-related information on merchandise that is not a target for affiliate services according to one or more embodiments;

FIG. 5 is view illustrating a configuration diagram of a merchandise adding function to add merchandise that is a target for affiliate services according to one or more embodiments;

FIG. 6 is a view illustrating a configuration diagram of a merchandise adding function to add merchandise that is not a target for affiliate services according to one or more embodiments;

FIG. 7 is a view illustrating a configuration diagram of a personal information providing function according to one or more embodiments; and

FIG. 8 is a view illustrating a configuration diagram of a ranking function according to one or more embodiments.

### DETAILED DESCRIPTION

Embodiments are explained with referring to drawings. In the respective drawings referenced herein, the same constitutions are designated by the same reference numerals and duplicate explanation concerning the same constitutions may be omitted. All of the drawings are provided to illustrate the respective examples only.

### System Overview

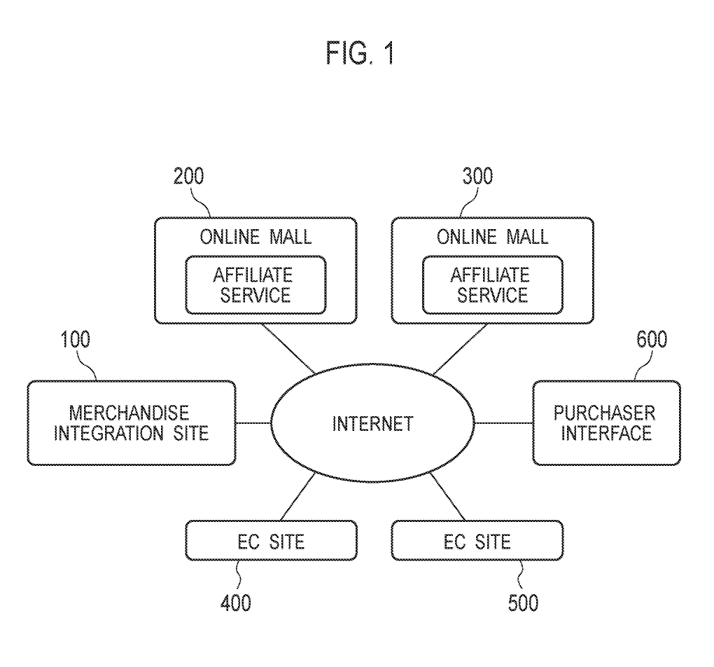

As illustrated in FIG. 1, the online mall systems 200 and 300 and EC site systems 400 and 500 are connected on the Internet. Also, a merchandise integration site system 100 and a purchaser interface system 600 are connected on the Internet. In the following description, the word “system” is omitted. In addition, the term “merchandise” in the disclosures may include not only merchandise (goods) but also providing services.

The online malls 200 and 300, the EC sites 400 and 500, and the merchandise integration site 100 each may include a web server. The purchaser interface 600 executes a web browser to display or indicate a webpage on a display device according to a program received from the web server of the merchandise integration site 100. The purchaser interface 600 also displays or indicates webpages, as needed, on the display device according to programs received from the web servers of the online malls 200 and 300 or the EC sites 400 and 500. Moreover, the purchaser interface 600 transmits predetermined information to a predetermined web server based on an input operation by a user. The display device to display or indicate webpages may include CRT (Cathode Ray Tube) display, LCD (Liquid Crystal Display) such as for PC and smartphone, and touch pad for example) and the like.

The online malls 200 and 300 provide affiliate services. The merchandise integration site 100 uses the affiliate services provided by the online malls 200 and 300 to publicize merchandise sold at the respective online malls 200 and 300 on the webpages. The merchandise integration site 100 also stores information on merchandise sold at the EC sites 400 and 500, and publicizes the merchandise sold at the EC sites on the webpages.

The purchaser interface 600 displays the webpages acquired from the web server of the merchandise integration site 100, thereby displaying the merchandise sold at the online malls 200 and 300 and the merchandise sold at the EC sites 400 and 500 while integrating the both into a single webpage. Thus, the user of the purchaser interface 600 can easily compare the merchandise from different distributors. The merchandise integration site 100 has functions to cross-search for the merchandise from the online malls 200 and 300 and the merchandise from the EC sites 400 and 500 according to a condition sent from the purchaser interface 600, and to integrate merchandise selected from among the merchandise from the respective online malls and the merchandise from the respective EC sites into a single webpage.

Here, merchandise from more than one EC site that does not perform affiliate services (without affiliate service) is normally not integrated into a single webpage. Such an attempt to integrate the merchandise from more than one site into a single webpage (hereinafter referred to as the integrated page) is driven by an incentive acting on a provider of the integrated page to gain rewards from the affiliate services. On the other hand, since no affiliate rewards are expected even though merchandise from more than one EC site that does not perform affiliate services is integrated, a service to integrate the merchandise from more than one EC site that does not perform affiliate services into a single webpage for search is normally not performed.

### Hardware of Each System

Each of the systems 100 to 600 may include a processing device, a storage device, an input device, a display device, and a communication device. Operations and functions of each system are realized by the processing device, including CPU (Central Processing Unit), executing programs. Programs and information to be used by the processing device for processing is read from the storage device such as memory. Then, information processed by the processing device is stored in the storage device. A system user inputs information through the input device. Such information is presented to the system user through the display device. Transmission and reception of information between the respective systems are performed through the communication device. The processing device, the storage device, the input device, and the display device may cooperate with each other in a plurality of servers in a distributed state in a network environment. More than one processing device and more than one storage device may be provided. More than one processing device or more than one storage device may cooperate with each other in a distributed state in a network environment.

### Cross-Search Function

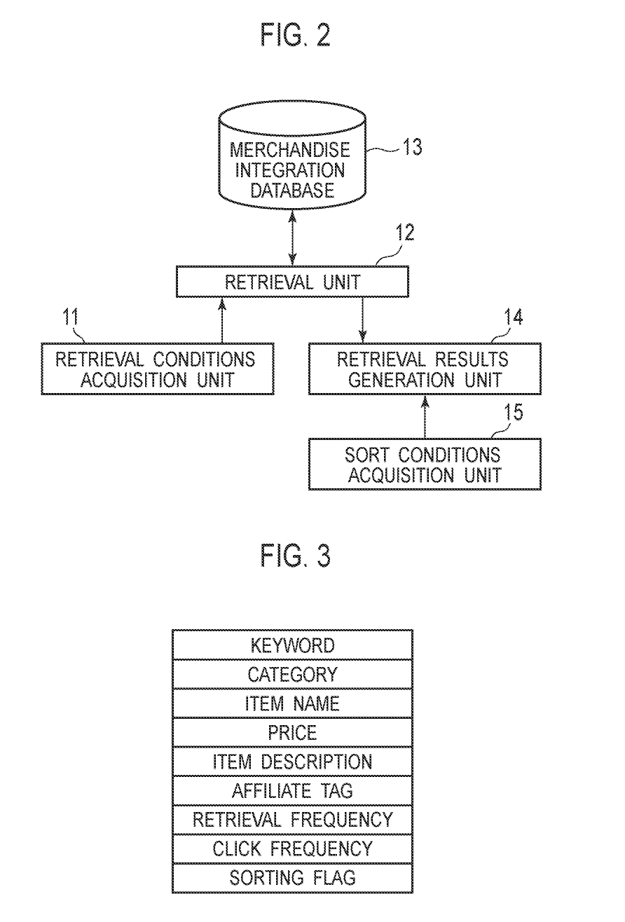

The merchandise integration site 100 executes a cross-search function. FIG. 2 is a view illustrating a configuration diagram of the cross-search function. A retrieval conditions acquisition unit 11 acquires retrieval conditions from the purchaser interface 600, and hands over the retrieval conditions to a retrieval unit 12. The retrieval unit 12 retrieves, from a merchandise integration database (DB) 13, merchandise-related information that meets the retrieval conditions handed over from the retrieval conditions acquisition unit 11, and hands over the retrieved merchandise-related information to a retrieval results generation unit 14.

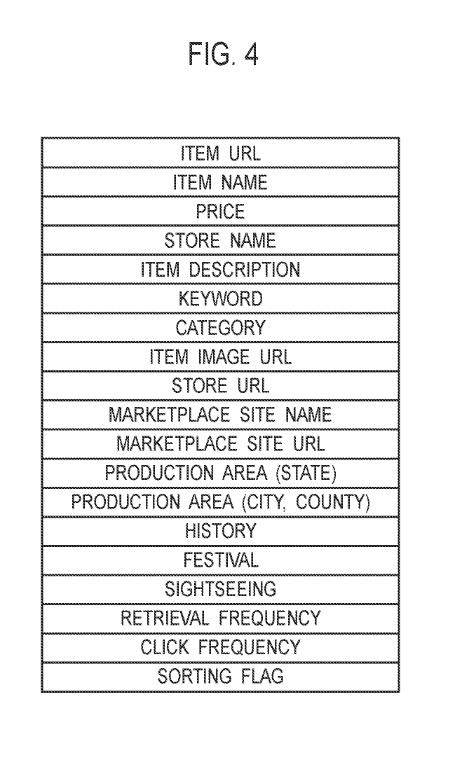

FIGS. 3 and 4 are views each illustrating a data structure of merchandise-related information stored in the merchandise integration DB 13. FIG. 3 is a view illustrating a data structure of merchandise-related information on merchandise sold at a site that performs affiliate services. Such merchandise corresponds to merchandise sold at the online malls 200 and 300 in this embodiment, and data association illustrated in FIG. 3 is stored for each piece of merchandise. More specifically, for each piece of merchandise, keyword, category, merchandise name, price, merchandise description, affiliate tag, retrieval frequency for merchandise, click frequency, and sorting flag are associated with each other. The sorting flag is a flag that serves as a mark for integrating only merchandise with a common flag on into a single webpage.

FIG. 4 is a view illustrating a data structure of merchandise-related information on merchandise sold at a site that performs no affiliate services. Such merchandise corresponds to merchandise sold at the EC sites 400 and 500 in this embodiment, and data association illustrated in FIG. 4 is stored for each piece of merchandise. More specifically, for each piece of merchandise, merchandise URL (URL of merchandise marketplace page), merchandise name, price, store name, merchandise description, keyword, category, merchandise image URL, store URL, marketplace site name, marketplace site URL, production area (state), production area (city, county), history information about merchandise, festival information about merchandise, sightseeing information about merchandise, retrieval frequency for merchandise, click frequency, and sorting flag are associated with each other.

Upon receipt of a retrieval word or a retrieval image as a retrieval condition from the retrieval conditions acquisition unit 11, the retrieval unit 12 retrieves, from the merchandise integration DB 13, merchandise-related information including a word corresponding to the retrieval word or an image corresponding to the retrieval image. In other words, merchandise-related information including a word corresponding to the retrieval word or an image corresponding to the retrieval image is retrieved from merchandise-related information on each merchandise with the data structures illustrated in FIGS. 3 and 4. The image is acquired from an image URL included in the affiliate tag in FIG. 3 or from the merchandise image URL in FIG. 4.

Alternatively, upon receipt of a sorting flag designated as a retrieval condition from the retrieval conditions acquisition unit 11, the retrieval unit 12 executes to retrieve, from the merchandise integration DB 13, merchandise-related information associated with a sorting flag corresponding to the sorting flag. In other words, merchandise-related information including the corresponding sorting flag is retrieved from merchandise-related information on each merchandise with the data structures illustrated in FIGS. 3 and 4. The sorting flag represents a group such as “recommended product” and “campaign product”, for example.

Alternatively, upon receipt of a price range designated as a retrieval condition from the retrieval conditions acquisition unit 11, the retrieval unit 12 narrows down the retrieval results to only merchandise-related information with the price included in the price range.

When merchandise-related information that is a hit as the retrieval result is the merchandise-related information illustrated in FIG. 3 that addresses affiliate services, the retrieval unit 12 extracts an affiliate tag from the merchandise-related information, and hands over the affiliate tag to the retrieval results generation unit 14.

On the other hand, when merchandise-related information that is a hit is the merchandise-related information illustrated in FIG. 4 that does not address affiliate services, the retrieval unit 12 reads the merchandise URL, merchandise name, price, merchandise description, and merchandise image URL from the merchandise-related information, and hands over the read information to the retrieval results generation unit 14.

Upon acquisition of the affiliate tag from the retrieval unit 12, the retrieval results generation unit 14 inserts the affiliate tag (affiliate part) into a retrieval results display webpage. Upon acquisition of more than one affiliate tag from the retrieval unit 12, the retrieval results generation unit 14 makes a list of merchandise by inserting the affiliate tags into the retrieval results display webpage.

Alternatively, upon acquisition of the merchandise URL, merchandise name, price, merchandise description, and merchandise image URL (hereinafter referred to as the “merchandise-publicizing materials”) from the retrieval unit 12, the retrieval results generation unit 14 uses these merchandise-publicizing materials to generate a merchandise-publicizing tag (merchandise-publicizing part) corresponding to the affiliate tag, and inserts the merchandise-publicizing tag into the retrieval results display webpage described above. The merchandise-publicizing part is configured, as an example, such that the merchandise name, price, and merchandise description are displayed, the merchandise image read from the merchandise image URL is displayed, and, when the merchandise-publicizing part is clicked, a merchandise marketplace page corresponding to the merchandise URL is displayed in another frame of the browser. Upon acquisition of the merchandise-publicizing materials corresponding to more than one merchandise from the retrieval unit 12, the retrieval results generation unit 14 makes a list of merchandise by generating merchandise-publicizing parts for each merchandise and inserting the generated merchandise-publicizing parts into the retrieval results display webpage described above.

A sorting conditions acquisition unit 15 receives a condition for sorting the retrieval results from the purchaser interface 600, and hands over the condition to the retrieval results generation unit 14. The retrieval results generation unit 14 sorts the affiliate parts and merchandise-publicizing parts to be listed as described above in order of price, retrieval frequency or click frequency, based on the sorting condition received from the sorting conditions acquisition unit 15.

Thus, the retrieval results generation unit 14 generates a retrieval results display webpage that combines the merchandise from the online malls 200 and 300 that perform affiliate services with the merchandise from the EC sites 400 and 500 that do not perform affiliate services on a single webpage. The retrieval results display webpage may be more than one page, and total number of webpages can be modified by adjusting number of merchandises, amount of information and the like. Total number of webpages can be reduced by increasing scroll range per a page.

Then, the retrieval results generation unit 14 transmits the generated retrieval results display webpage to the purchaser interface 600 through the web server. Thus, the user of the purchaser interface 600 can view the retrieval results display webpage that combines the merchandise from the online malls 200 and 300 that perform affiliate services with the merchandise from the EC sites 400 and 500 that do not perform affiliate services on a single webpage, and can easily compare the merchandise displayed on the webpage. Furthermore, the user can purchase the merchandise by moving to the merchandise marketplace page from links attached to the displayed affiliate parts or merchandise-publicizing parts.

The operations of the retrieval conditions acquisition unit 11, the retrieval unit 12, the retrieval results generation unit 14, and the sorting conditions acquisition unit 15 are realized by the processing device in the merchandise integration site 100 executing programs. The merchandise integration DB 13 is stored in the storage device of the merchandise integration site 100.

### Online Mall Merchandise Adding Function

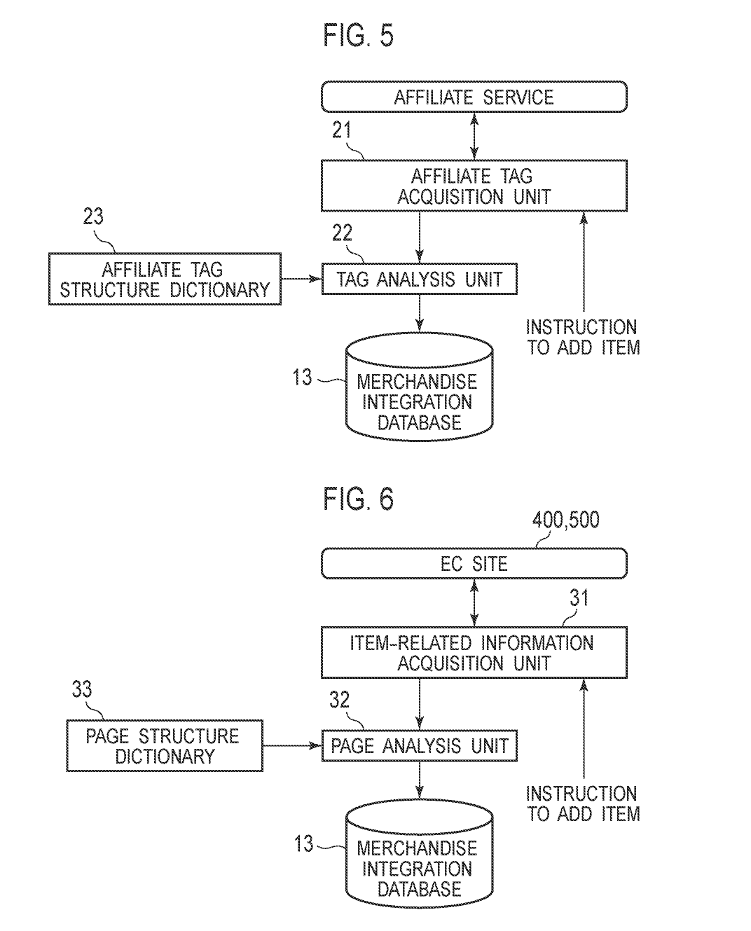

Next, description is given of a function to register the merchandise from the online malls 200 and 300 that perform affiliate services with the merchandise integration DB 13. FIG. 5 is a view illustrating a configuration diagram of the merchandise adding function.

(First Operation)

An affiliate tag acquisition unit 21 in the merchandise integration site 100 receives an instruction to add merchandise from an arbitrary system having the authority to add merchandise. The instruction to add merchandise has a previously acquired affiliate tag attached thereto. The affiliate tag acquisition unit 21 acquires the affiliate tag attached to the instruction to add merchandise, and hands over the affiliate tag to a tag analysis unit 22. The tag analysis unit 22 acquires an identifier (for example, domain) of the affiliate service from the description of the affiliate tag. For this purpose, it is conceivable that identifiers of affiliate services are pre-registered in a dictionary and, when the tag analysis unit 22 finds in the affiliate tag an identifier that matches the identifier registered in the dictionary, the identifier is acquired as the identifier of the affiliate service.

The tag analysis unit 22 extracts the merchandise name, price, and merchandise description from the affiliate tag by referring to an affiliate tag structure dictionary 23. For this purpose, the identifier of the affiliate service and the structure of the affiliate tag (information indicating where in the tag the merchandise name, price, and merchandise description are described) are associated with each other and pre-registered in the affiliate tag structure dictionary 23 for each affiliate service.

The tag analysis unit 22 registers the affiliate tag attached to the instruction to add merchandise and the merchandise name, price, and merchandise description extracted from the affiliate tag in the merchandise integration DB 13 in association with each other. Thus, a record of the merchandise-related information illustrated in FIG. 3 is added to the merchandise integration DB 13. Among the added merchandise-related information, the retrieval frequency and the click frequency have their initial values set to 0. When a keyword, category or sorting flag is attached to the instruction to add merchandise, such a keyword, category or sorting flag may be registered with the merchandise integration DB 13 in association with the affiliate tag.

The operations of the affiliate tag acquisition unit 21 and the tag analysis unit 22 described above are realized by the processing device in the merchandise integration site 100 executing programs. Also, each dictionary is stored in the storage device.

(Second Operation)

The affiliate tag acquisition unit 21 in the merchandise integration site 100 receives an instruction to add merchandise from an arbitrary system having the authority to add merchandise. A retrieval word for retrieving merchandise from an affiliate service is attached to the instruction to add merchandise. The affiliate tag acquisition unit 21 acquires, from the affiliate service, an affiliate tag of merchandise corresponding to the retrieval word attached to the instruction to add merchandise, through an automatic acquisition process such as crawler and autopilot. The affiliate tag acquisition unit 21 hands over the affiliate tag acquired through the automatic acquisition process and an identifier of the affiliate service that has generated the tag to the tag analysis unit 22.

The tag analysis unit 22 extracts the merchandise name, price, and merchandise description from the affiliate tag by referring to the affiliate tag structure dictionary 23. The identifier of the affiliate service and the structure of the affiliate tag (information indicating where in the tag the merchandise name, price, and merchandise description are described) are associated with each other and pre-registered in the affiliate tag structure dictionary 23 for each affiliate service.

The tag analysis unit 22 registers the affiliate tag acquired from the affiliate service and the merchandise name, price, and merchandise description extracted from the affiliate tag in the merchandise integration DB 13 in association with each other. Thus, the record of the merchandise-related information illustrated in FIG. 3 is automatically added to the merchandise integration DB 13. Among the added merchandise-related information, the retrieval frequency and the click frequency have their initial values set to 0. When a keyword or sorting flag is attached to the instruction to add merchandise, such a keyword or sorting flag may be registered with the merchandise integration DB 13 in association with the affiliate tag.

The operations of the affiliate tag acquisition unit 21 and the tag analysis unit 22 described above are realized by the processing device in the merchandise integration site 100 executing programs. Also, each dictionary is stored in the storage device. Moreover, the record of the merchandise-related information can be updated to latest data on a regular basis by storing in the storage device the retrieval word attached to the instruction to add merchandise and repeating the second operation described above based on the retrieval word on a regular basis by the processing device. During this record update, the values of the retrieval frequency and the click frequency before the update are maintained, rather than resetting the values.

(Third Operation)

The online malls 200 and 300 provide a Web application programming interface (WebAPI). The WebAPI may be generally defined as ‘application programming interface for either a web server or a web browser. In this case, the processing device in the merchandise integration site system 100 receives an instruction to add merchandise from an arbitrary system having the authority to add merchandise. An identifier of the WebAPI and an input parameter to be handed over to the WebAPI are attached to the instruction to add merchandise. The processing device transmits the input parameter to a WebAPI corresponding to the WebAPI identifier, and receives an output parameter, as a response, including affiliate data from the WebAPI. It is assumed in this embodiment that, according to the specifications of the WebAPI, the merchandise-related information including the respective pieces of data illustrated in FIG. 3 associated with each other can be received as the output parameter. The processing device registers the merchandise-related information acquired from the WebAPI with the merchandise integration DB 13.

Thus, the record of the merchandise-related information illustrated in FIG. 3 is automatically added to the merchandise integration DB 13. Among the added merchandise-related information, the retrieval frequency and the click frequency have their initial values set to 0. When a keyword or sorting flag is attached to the instruction to add merchandise, such a keyword or sorting flag may be registered with the merchandise integration DB 13 in association with the affiliate tag (affiliate data).

The operations described above are realized by the processing device in the merchandise integration site 100 executing programs. Moreover, the record of the merchandise-related information can be updated to latest data on a regular basis by storing in the storage device the association between the identifier of the WebAPI attached to the instruction to add merchandise and the input parameter given to the WebAPI, and repeating the third operation described above, based on the identifier of the WebAPI and the input parameter given to the WebAPI, on a regular basis by the processing device. During this record update, the values of the retrieval frequency and the click frequency before the update are maintained, rather than resetting the values.

### EC Site Merchandise Adding Function

Next, description is given of a function to register the merchandise from the EC sites 400 and 500 that do not perform affiliate services with the merchandise integration DB 13. FIG. 6 is a view illustrating a configuration diagram of the merchandise adding function.

(First Operation)

A merchandise-related information acquisition unit 31 in the merchandise integration site 100 receives an instruction to add merchandise from an arbitrary system having the authority to add merchandise. The merchandise-related information described with reference to FIG. 4 is attached to the instruction to add merchandise. The merchandise-related information acquisition unit 31 acquires the merchandise-related information attached to the instruction to add merchandise, and registers the merchandise-related information with the merchandise integration DB 13. Thus, a record of the merchandise-related information illustrated in FIG. 4 is added to the merchandise integration DB 13. Among the added merchandise-related information, the retrieval frequency and the click frequency have their initial values set to 0. Here, the system that gives the instruction to add merchandise may be a computer operated by an EC site operator. The function of the merchandise-related information acquisition unit 31 may be provided by an “import WebAPI (Web Application Programing Interface)” provided by the integration site 100. The “import WebAPI” may be defined as a WebAPI that acquires merchandise-related information from an arbitrary system having the authority to add merchandise, and registers the acquired merchandise-related information with the merchandise integration DB 13. Although it has heretofore been technically difficult to import contents of minor sites without such an import mechanism, the use of such a new mechanism makes it possible to import information on minor sites (EC sites) and the like that do not perform affiliate services. A computer that sends the instruction to add merchandise may acquire merchandise-related information by importing information inputted by a user of the computer on a screen through a GUI.

The operations of the merchandise-related information acquisition unit 31 described above are realized by the processing device in the merchandise integration site 100 executing programs.

(Second Operation)

The merchandise-related information acquisition unit 31 in the merchandise integration site 100 receives an instruction to add merchandise from an arbitrary system having the authority to add merchandise. A URL of an EC site to be added is attached to the instruction to add merchandise. The merchandise-related information acquisition unit 31 acquires a marketplace page of each merchandise sold at the EC site to be added, through an automatic acquisition process such as crawler and autopilot, and hands over the marketplace page to a page analysis unit 32. Here, the system that gives the instruction to add merchandise may be a computer operated by an EC site operator. The function of the merchandise-related information acquisition unit 31 may be provided by the “import WebAPI” provided by the integration site 100. The page analysis unit 32 analyzes a source code of a marketplace page for each merchandise, and extracts the merchandise-related information illustrated in FIG. 4 from the page.

The page analysis unit 32 refers to a page structure dictionary 33 to extract the merchandise-related information from the source code of the marketplace page. In the page structure dictionary 33, an identifier of an EC site and the structure of the marketplace page of the EC site (information indicating where in the page each merchandise-related information illustrated in FIG. 4 is described) are associated with each other and pre-registered for each EC site. The page analysis unit 32 refers to the structure of the marketplace page associated with the identifier of the EC site to be added by reading the structure from the page structure dictionary 33. The page analysis unit 32 may extract each merchandise-related information by referring to metadata, a tag or an identifier in the tag, which is described in the marketplace page for each merchandise-related information. Alternatively, when the marketplace page uses Semantic Web technology, that is, merchandise-related information is extracted from a marketplace page described using an RDF or the like, or a marketplace page accompanied by a tag (back data) describing the meaning of data, there may be no need for the page structure dictionary 33. In this case, the page analysis unit can extract the merchandise-related information by using Semantic Web technology to interpret the meaning of data.

The page analysis unit 32 registers the extracted merchandise-related information with the merchandise integration DB 13 for each merchandise. Thus, the record of the merchandise-related information illustrated in FIG. 4 is automatically added to the merchandise integration DB 13. Among the added merchandise-related information, the retrieval frequency and the click frequency have their initial values set to 0.

The operations of the merchandise-related information acquisition unit 31 and the page analysis unit 32 described above are realized by the processing device in the merchandise integration site 100 executing programs. Also, the page structure dictionary 33 is stored in the storage device. Moreover, the record of the merchandise-related information can be updated to latest data on a regular basis by storing in the storage device the EC site URL (identifier) attached to the instruction to add merchandise and repeating the second operation described above based on the EC site URL on a regular basis by the processing device. During this record update, the values of the retrieval frequency and the click frequency before the update are maintained, rather than resetting the values.

Here, during the extraction of the merchandise-related information illustrated in FIG. 4 from the marketplace page of each merchandise in the second operation described above, the processing device in the merchandise integration site 100 may use Semantic Web technology. Semantic Web technology is a technology to enable a computer to efficiently collect and interpret information by adding, for a Web page and the contents described therein, information (metadata) indicating what the Web page and the contents mean, according to certain rules. In this case, the merchandise-related information automatically extracted from the merchandise marketplace page could be wrong. Therefore, in such a case, the processing device in the merchandise integration site 100 may include a revision function to display the merchandise-related information extracted using Semantic Web technology on a user interface of a terminal that has transmitted the instruction to add merchandise described above, to receive an instruction to correct the merchandise-related information from a terminal user who has confirmed the display, and to register, with the merchandise integration DB 13, the merchandise-related information corrected according to the received correction instruction.

### Personal Information Providing Function

The user of the purchaser interface 600 views a retrieval results display webpage for merchandise and then moves to a marketplace page for the merchandise by clicking an affiliate part or merchandise-publicizing part of the merchandise that appears on the page. Furthermore, when having decided to purchase the merchandise, the user of the purchaser interface 600 proceeds with a purchase procedure for the merchandise from the marketplace page of the merchandise. In the purchase procedure, the user needs to enter his/her name and address to which the purchased merchandise is to be delivered. The merchandise integration site 100 provides the purchaser interface 600 with personal information, such as the name and address for delivery of the merchandise and payment information, and an automatic input program for automatically entering the personal information into an order form on the marketplace site. As software for automatically entering information into a web form, software for entering into a prize application form, for example, and the like are known. This personal information providing function is described below.

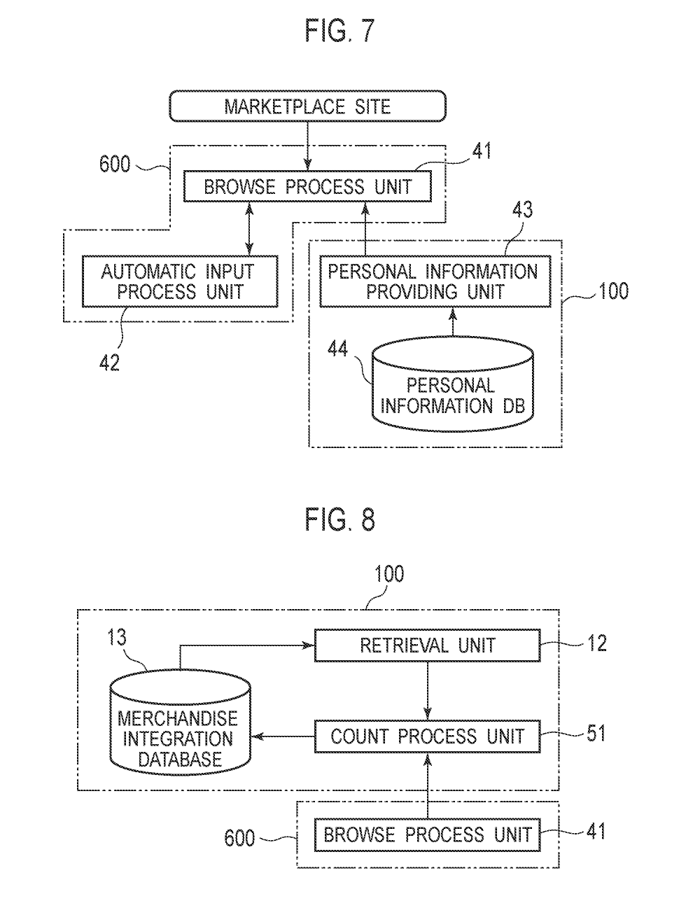

FIG. 7 is a view illustrating a configuration diagram of the personal information providing function. Hereinafter, the online malls 200 and 300 and the EC sites 400 and 500 where the purchase procedure is performed are collectively referred to as the “marketplace site”. In FIG. 7, the purchaser interface 600 may include a browsing processing unit 41 and an automatic input processing unit 42. Operations of the browsing processing unit 41 and the automatic input processing unit 42 are realized by the processing device of the purchaser interface 600 executing programs provided by the merchandise integration site 100. The automatic input program may be pre-installed in the purchaser interface 600.

The merchandise integration site 100 may include a personal information providing unit 43 and a personal information DB 44. Operations of the personal information providing unit 43 are realized by the processing device of the merchandise integration site 100 executing programs. The personal information DB 44 is stored in the storage device. In the personal information DB, an identifier of an individual and personal information asked to be entered when purchasing merchandise, such as address, name, telephone number, and payment information of the individual, are stored in association with each other. Such personal information may be information on a representative of a group when merchandise is purchased by the group.

It is assumed, here, that the user of the purchaser interface 600, who uses the merchandise integration site 100, uses his/her personal identifier to previously log in to the merchandise integration site 100. Therefore, it is assumed that the merchandise integration site 100 specifies the identifier of the individual that is the user of the purchaser interface 600.

In the purchaser interface 600, the browsing processing unit 41 displays the retrieval results display webpage on the display device. Upon detection of an event that the affiliate part or merchandise-publicizing part displayed on the retrieval results display webpage is clicked by the input device, the browsing processing unit 41 acquires a merchandise marketplace page from a link attached to the part, and displays the marketplace page in a frame different from a display region where the retrieval results display webpage is opened.

The user of the purchaser interface 600 moves from the marketplace page to an order page (personal information input page) and then to a payment page (payment information input page) within the frame where the marketplace page for the online malls 200 and 300 or the EC sites 400 and 500 is opened. In this event, upon detection of an event of requesting automatic input from the input device, the browsing processing unit 41 requests the merchandise integration site 100 to provide personal information on the user of the purchaser interface 600. The event of requesting automatic input is, for example, a user operation showing agreement through the input device, in response to the question “Do you wish to automatically enter your personal information?”. The personal information to be requested may be only a part of the personal information registered, such as the address only or the name only. Here, the browsing processing unit 41 may be configured to request the merchandise integration site 10 to provide the personal information described above, regardless of whether or not the event of requesting automatic input is detected.

In response to this request, the personal information providing unit 43 in the merchandise integration site 100 reads the personal information associated with the identifier of the user of the purchaser interface 600 from the personal information DB 44, and transmits the personal information to the purchaser interface 600. The browsing processing unit 41 in the purchaser interface 600 acquires the personal information transmitted from the merchandise integration site 100, and hands over the personal information to the automatic input processing unit 42.

Upon acquisition of the personal information, the automatic input processing unit 42 automatically enters relevant personal information into the form on the order page or payment page displayed within the frame. The user checks the automatically entered personal information, performs addition and correction as needed, and proceeds with the purchase procedure. This personal information providing function can provide the marketplace site with the personal information consolidated outside the marketplace site, thus making it possible to spare the user of the purchaser interface 600 the trouble of having to enter his/her personal information when purchasing merchandise.

### Ranking Function

Next, a ranking function is described. In the above description of the cross-search function, the description is given of the fact that the retrieval results can be sorted by the retrieval frequency or the click frequency. Here, description is given of a function to update parameters of the retrieval frequency and the click frequency in the merchandise-related information stored in the merchandise integration DB 13.

FIG. 8 is a view illustrating a configuration diagram of the ranking function. The merchandise integration site 100 may include a count processing unit 51 in addition to the retrieval unit 12 and the merchandise integration DB 13 described above. Operations of the count processing unit 51 are realized by the processing device in the merchandise integration site 100 executing programs.

In the merchandise integration site 100, the count processing unit 51 updates the value of the retrieval frequency in the merchandise integration DB 13 by adding 1 to the value of the retrieval frequency among the merchandise-related information, for each of the merchandise retrieved by the retrieval unit 12 using the cross-search function described above.

Meanwhile, in the purchaser interface 600, when the user clicks on the affiliate part or merchandise-publicizing part, the browsing processing unit 41 detects the click event and transmits the identifier of the affiliate part or merchandise-publicizing part that has been clicked on to the merchandise integration site 100. In the merchandise integration site 100, the count processing unit 51 acquires the identifier of the part that has been clicked on, and updates the value of the click frequency in the merchandise integration DB 13 by adding 1 to the value of the click frequency among the merchandise-related information corresponding to the identifier of the part. For this purpose, the merchandise-related information in the merchandise integration DB 13 is previously associated with the identifier of the part, and each affiliate part or merchandise-publicizing part is previously associated with the identifier of the part within the retrieval results display webpage of the cross-search.

As described above, the retrieval results generation unit 14 sorts the affiliate parts and merchandise-publicizing parts to be listed in order of price, retrieval frequency or click frequency, based on the sorting condition received from the sorting conditions acquisition unit 15. In this event, as for the retrieval frequency and the click frequency, the retrieval frequency or click frequency added by the above processing is referred to.

Moreover, keywords and categories are connected to the merchandise-related information for the affiliate part or merchandise-publicizing part. Therefore, the merchandise integration site 100 may rank the keywords or categories with higher retrieval frequency or click frequency, based on the merchandise-related information, and provide the ranking to the purchaser interface 600. Accordingly, the purchaser of merchandise can be provided with the ranking of keywords or categories counted in a cross-sectoral manner through the sites of the online malls 200 and 300 that perform affiliate services and the EC sites 400 and 500 that do not perform affiliate services.

### Cooperation with Transaction Management System

The inventor of the disclosures has invented a transaction management system disclosed in Japanese Patent Application Publication No. 2012-178147. This transaction management system may manage transactions through marketplace sites such as the EC sites 400 and 500.

### Equipped with ASP Function

The merchandise integration site 100 may be equipped with a function as an affiliate service provider having the configuration described above.

More specifically, the merchandise integration site 100 may include: a storage unit that stores partner IDs and affiliate rewards corresponding to the respective partner IDs; a transmission unit that generates a link code connecting merchandise-related information requested by a partner with the ID of the partner, and transmits the link code to the partner; and an execution unit that registers affiliate result rewards in the storage unit in association with the partner ID connected with the link code when merchandise corresponding to the link code is purchased by accessing the link code.

With the merchandise integration site 100 equipped with the affiliate service provider function, the sales by using affiliate services can be improved particularly for merchandise from EC sites that have not introduced the affiliate services.

### Affinity for Internet of Things (IoT)

When a device (for example, refrigerator) connected to the Internet purchases merchandise on behalf of a consumer, where to purchase the merchandise is limited by the aptitude of specifications of the device and specifications of a marketplace site to purchaser the device. Due to the affiliation between a refrigerator manufacturer and a well-known marketplace site (for example, Rakuten Ichiba, Amazon, and the like), the refrigerator is normally purchased from a specific major shopping mall, and unlikely to be purchased from any other minor sites. On the other hand, if the device is purchased from the merchandise integration site of the disclosure, the merchandise integration sites may include both merchandise sold at the major shopping mall and merchandise from the minor sites. Moreover, since it is easy for new minor sites to register merchandise with the merchandise integration site, the device connected to the Internet can automatically purchase merchandise from among a wide range of options of where to purchase, including the minor sites.

Likewise, by connecting a vending machine installed in a station or the like to the Internet, the vending machine can purchase from the merchandise integration site of the disclosure (the vending machine in this case sells merchandise that is not available in the machine). Accordingly, the vending machine can sell merchandise sold at a local site, merchandise sold at a site of chamber of commerce, and the like in a cross-sectoral manner.

### CONCLUSION

Thus, the merchandise from marketplace sites that do not provide affiliate services is presented to consumers viewing the retrieval results display webpage, in a combined state with the merchandise from other marketplace sites that do not provide affiliate services or from other marketplace sites that provide affiliate services. Therefore, the disclosure makes it easier for the merchandise from marketplace sites that do not provide affiliate services to get noticed by the consumers, compared with the case where the merchandise is sold alone. Moreover, the disclosure makes it easy to compare the merchandise from marketplace sites that do not provide affiliate services with the merchandise from other marketplace sites.

The scope of the disclosure is not limited to the above embodiment, but is the scope of the disclosure described in the scope of claims. A specific information communication technology on each system and an information communication technology between systems can be replaced by technologies known to those skilled in the art. Also, the same processing results may be obtained even when the processing order of processes is partially changed. Moreover, according to the above embodiment, merchandise from marketplace sites that provide affiliate services and merchandise from marketplace sites that do not provide affiliate services are integrated into an integration site, and cross-search for the merchandise between the marketplace sites is realized to enable the retrieved merchandise to be purchased. However, the disclosure is not limited thereto but may be configured such that at least merchandise from marketplace sites that do not provide affiliate services are integrated into the integration site, and cross-search for the merchandise between the marketplace sites is realized.

The disclosure includes other embodiments in addition to the above-described embodiments without departing from the spirit of the disclosure. The embodiments are to be considered in all respects as illustrative, and not restrictive. The scope of the disclosure is indicated by the appended claims rather than by the foregoing description. Hence, all configurations including the meaning and range within equivalent arrangements of the claims are intended to be embraced in the description.

What is claimed is:

1. A merchandise purchase assist system comprising:
a storage unit that stores merchandise-related information concerning merchandise from marketplace sites that do not provide affiliate services and merchandise-related information concerning merchandise from other marketplace sites;
a retrieval conditions acquisition unit that receives a retrieval condition for the merchandise-related information from a purchaser interface system;
a retrieval unit that retrieves, from the storage unit, the merchandise-related information matching the retrieval condition; and
a retrieval results generation unit that inserts, into a retrieval results display webpage, one merchandise-publicizing part including the merchandise-related information retrieved by the retrieval unit concerning merchandise at marketplace sites that do not provide affiliate services, and another merchandise-publicizing part or an affiliate part including the merchandise-related information retrieved by the retrieval unit concerning merchandise at other marketplace sites, wherein
the merchandise purchase assist system transmits the retrieval results display webpage in which the one merchandise-publicizing part and the other merchandise-publicizing part or affiliate part are combined to the purchaser interface system.

2. The merchandise purchase assist system according to claim 1, wherein
the retrieval results generation unit inserts the one merchandise-publicizing part and the other merchandise-publicizing part or affiliate part, which are to be inserted into the retrieval results display webpage, by sorting them based on ranking determination elements contained in the merchandise-related information.

3. The merchandise purchase assist system according to claim 1, further comprising:
a second storage unit that stores personal information required to purchase merchandise, wherein
when personal information on a user of the purchaser interface system is requested by the purchaser interface system, the personal information is read from the second storage unit, and the read personal information is transmitted to the purchaser interface system in order to automatically enter the personal information into an order page or payment page form on the marketplace site associated with the one merchandise-publicizing part or the other merchandise-publicizing part or affiliate part in the purchaser interface system.

4. The merchandise purchase assist system according to claim 1, further comprising:
a merchandise-related information acquisition unit that acquires, through WebAPI, the merchandise-related information concerning merchandise from marketplace sites that do not provide affiliate services.

5. The merchandise purchase assist system according to claim 1, wherein the purchaser interface system includes a display device that indicates the retrieval results display webpage.

6. The merchandise purchase assist system according to claim 1, wherein the retrieval unit has functions to cross-search for both the merchandise from marketplace sites that do not provide affiliate services and the merchandise-related information concerning merchandise from other marketplace sites.

7. The merchandise purchase assist system according to claim 6, wherein the retrieval unit executes the cross-search upon receipt of a sorting flag from the retrieval conditions acquisition unit.
